(19) United States
(12) Patent Application Publication
(10) Pub. No.: US 2022/0114532 A1
(43) Pub. Date: Apr. 14, 2022

(54) CAPABILITY AND SKILLS MATRIX ANALYSIS IN GAP IDENTIFICATION AND REMEDIATION

(71) Applicant: International Business Machines Corporation, Armonk, NY (US)

(72) Inventors: Michael Nicholas Virnoche, Flowery Branch, GA (US); Shikhar Kwatra, San Jose, NC (US); Jennifer L. Szkatulski, Rochester, MI (US); Adam Lee Griffin, Dubuque, IA (US); Marina Milazzo, Sugar Hill, GA (US)

(21) Appl. No.: 17/067,820

(22) Filed: Oct. 12, 2020

(51) Int. Cl. G06Q 10/06; G06N 20/00

(52) U.S. Cl. CPC G06Q 10/063112; G06N 20/00; G06Q 10/063118

(57) ABSTRACT

Technology for a computer system that uses unsupervised machine learning (ML) for determining employment training opportunities that individuals can take to make the individuals better suited to fill skill gaps that exist in an enterprise (for example, a company that manufactures commercial products or provides commercial services). Some embodiments include remediation techniques. Some embodiments include a solutions-oriented toolset.

### BACKGROUND

The present invention relates generally to the field of computer systems for suggesting individuals that can be used to fill “skill gaps” in an enterprise and also to the field of unsupervised machine learning.

The Wikipedia entry for “unsupervised learning” (as of 27 Feb. 2020) states as follows: “Unsupervised learning is a type of machine learning that looks for previously undetected patterns in a data set with no pre-existing labels and with a minimum of human supervision. In contrast to supervised learning that usually makes use of human-labeled data, unsupervised learning, also known as self-organization, allows for modeling of probability densities over inputs. It forms one of the three main categories of machine learning, along with supervised and reinforcement learning. Semi-supervised learning, a related variant, makes use of supervised and unsupervised techniques. Two of the main methods used in unsupervised learning are principal component and cluster analysis. Cluster analysis is used in unsupervised learning to group, or segment, datasets with shared attributes in order to extrapolate algorithmic relationships. Cluster analysis is a branch of machine learning that groups the data that has not been labelled, classified or categorized. Instead of responding to feedback, cluster analysis identifies commonalities in the data and reacts based on the presence or absence of such commonalities in each new piece of data. This approach helps detect anomalous data points that do not fit into either group . . . . [Unsupervised learning] could be contrasted with supervised learning by saying that whereas supervised learning intends to infer a conditional probability distribution p X (x|y) {\textstyle p_{X}(x\,|\,y)} {\textstyle p_{X}(x\,|\,y)} conditioned on the label y {\textstyle y} {\textstyle y} of input data; unsupervised learning intends to infer an a priori probability distribution p X (x) {\textstyle p_{X} (x)} {\textstyle p_{X}(x)}. Generative adversarial networks can also be used with supervised learning, though they can also be applied to unsupervised and reinforcement techniques.” (footnotes omitted)

U.S. Patent Application Publication US 2018/0365229 (“Buhrmann”) states as follows: “This document describes a computational system for analyzing an organizational talent pool and identifying skill gaps allowing the organization to achieve its goals in performing assigned tasks. Computational tools are provided for talent pool optimization and recommendation with respect to its evolving objectives and requirements. In accordance with a preferred embodiment of the present invention, computational components (tools) include: machine-learning models based on deep neural networks to process and extract information from a variety of information sources including resumes, organizational experience requirements, job descriptions, etc.; sematic models created for the extracted information to support similarity measurement among multiple information sources; establishment of relationships among multiple information sources in the form of organizational macro services and dynamic models; and optimization methods for solving the semantic relatedness, gap and talent analysis, talent optimization and recommendation using efficient computational algorithms.”

### SUMMARY

According to an aspect of the present invention, there is a method, computer program product and/or system that performs the following operations (not necessarily in the following order): (i) receiving a project milestone data set including information identifying and relating to a plurality of milestones (M1 to Mk, where k is an integer) that define a work project to be performed by the enterprise; (ii) identifying, by machine logic, a plurality of project skills (S1 to Sm, where m is an integer) needed to complete work associated with the work project based on the project milestone data set; (iii) receiving a first version of a project talent pool data set including indicative of a first version of a project talent pool, with the first version of the project talent pool being a plurality of assigned workers (A1 to An, where n is an integer) which is a subset of the plurality of workers of the enterprise, with the plurality of assigned workers being workers currently assigned to work on the work project; (iv) analyzing, by machine logic, availability and skills of the first version of the project talent pool to associate the assigned workers with the project skills; and (v) determining, by machine logic, that first project skill S1 is a skill that is not met by any of the assigned workers of the first version of the project talent pool to identify first project skill S1 as a first skill gap with respect to the work project and the first version of the project talent pool.

### BRIEF DESCRIPTION OF THE DRAWINGS

FIG. 1 is a block diagram view of a first embodiment of a system according to the present invention;

FIG. 2 is a flowchart showing a first embodiment method performed, at least in part, by the first embodiment system;

FIG. 3 is a block diagram showing a machine logic (for example, software) portion of the first embodiment system;

FIG. 4 is a screenshot view generated by the first embodiment system; and

FIG. 5 is a block diagram view of a second embodiment of a system according to the present invention.

### DETAILED DESCRIPTION

Some embodiments of the present invention are directed to a computer system that uses unsupervised machine learning (ML) for determining employment training opportunities that individuals can take to make the individuals better suited to fill skill gaps that exist in an enterprise (for example, a company that manufactures commercial products or provides commercial services). Some embodiments include remediation techniques. Some embodiments include a solutions-oriented toolset. This Detailed Description section is divided into the following subsections: (i) The Hardware and Software Environment; (ii) Example Embodiment; (iii) Further Comments and/or Embodiments; and (iv) Definitions.

### I. The Hardware and Software Environment

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (for example, light pulses passing through a fiber-optic cable), or electrical signals transmitted through a wire.

A “storage device” is hereby defined to be anything made or adapted to store computer code in a manner so that the computer code can be accessed by a computer processor. A storage device typically includes a storage medium, which is the material in, or on, which the data of the computer code is stored. A single “storage device” may have: (i) multiple discrete portions that are spaced apart, or distributed (for example, a set of six solid state storage devices respectively located in six laptop computers that collectively store a single computer program); and/or (ii) may use multiple storage media (for example, a set of computer code that is partially stored in as magnetic domains in a computer's non-volatile storage and partially stored in a set of semiconductor switches in the computer's volatile memory). The term “storage medium” should be construed to cover situations where multiple different types of storage media are used.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

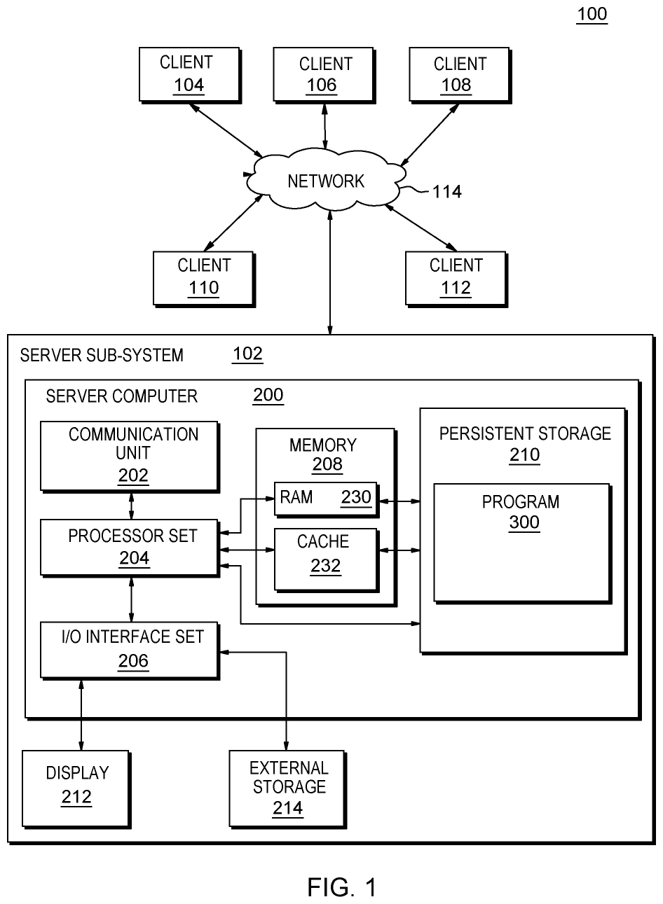

As shown in FIG. 1, networked computers system 100 is an embodiment of a hardware and software environment for use with various embodiments of the present invention. Networked computers system 100 includes: server subsystem 102 (sometimes herein referred to, more simply, as subsystem 102); client subsystems 104, 106, 108, 110, 112; and communication network 114. Server subsystem 102 includes: server computer 200; communication unit 202; processor set 204; input/output (I/O) interface set 206; memory 208; persistent storage 210; display 212; external device(s) 214; random access memory (RAM) 230; cache 232; and program 300.

Subsystem 102 may be a laptop computer, tablet computer, netbook computer, personal computer (PC), a desktop computer, a personal digital assistant (PDA), a smart phone, or any other type of computer (see definition of “computer” in Definitions section, below). Program 300 is a collection of machine readable instructions and/or data that is used to create, manage and control certain software functions that will be discussed in detail, below, in the Example Embodiment subsection of this Detailed Description section.

Subsystem 102 is capable of communicating with other computer subsystems via communication network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client subsystems.

Subsystem 102 is shown as a block diagram with many double arrows. These double arrows (no separate reference numerals) represent a communications fabric, which provides communications between various components of subsystem 102. This communications fabric can be implemented with any architecture designed for passing data and/or control information between processors (such as microprocessors, communications and network processors, etc.), system memory, peripheral devices, and any other hardware components within a computer system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for subsystem 102; and/or (ii) devices external to subsystem 102 may be able to provide memory for subsystem 102. Both memory 208 and persistent storage 210: (i) store data in a manner that is less transient than a signal in transit; and (ii) store data on a tangible medium (such as magnetic or optical domains). In this embodiment, memory 208 is volatile storage, while persistent storage 210 provides nonvolatile storage. The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202 provides for communications with other data processing systems or devices external to subsystem 102. In these examples, communications unit 202 includes one or more network interface cards. Communications unit 202 may provide communications through the use of either or both physical and wireless communications links. Any software modules discussed herein may be downloaded to a persistent storage device (such as persistent storage 210) through a communications unit (such as communications unit 202).

I/O interface set 206 allows for input and output of data with other devices that may be connected locally in data communication with server computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. I/O interface set 206 also connects in data communication with display 212. Display 212 is a display device that provides a mechanism to display data to a user and may be, for example, a computer monitor or a smart phone display screen.

In this embodiment, program 300 is stored in persistent storage 210 for access and/or execution by one or more computer processors of processor set 204, usually through one or more memories of memory 208. It will be understood by those of skill in the art that program 300 may be stored in a more highly distributed manner during its run time and/or when it is not running. Program 300 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### II. Example Embodiment

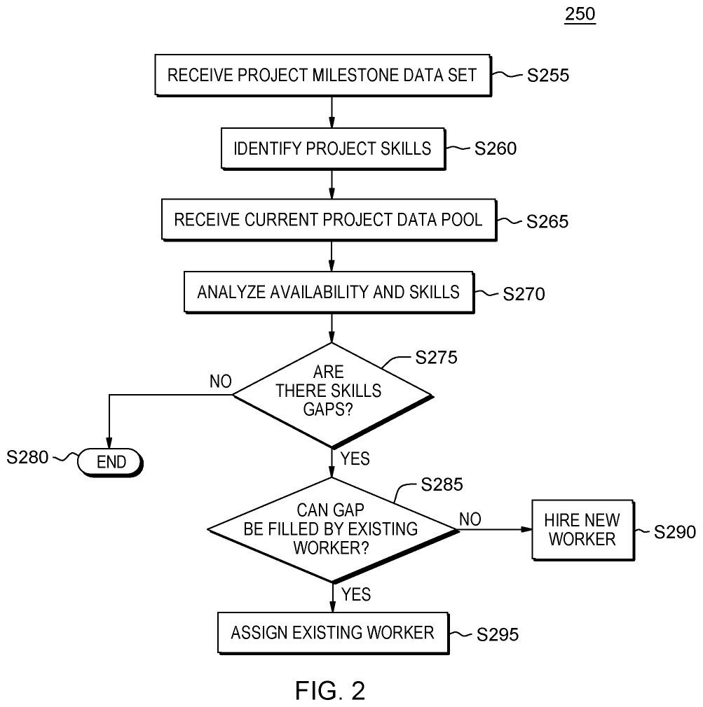

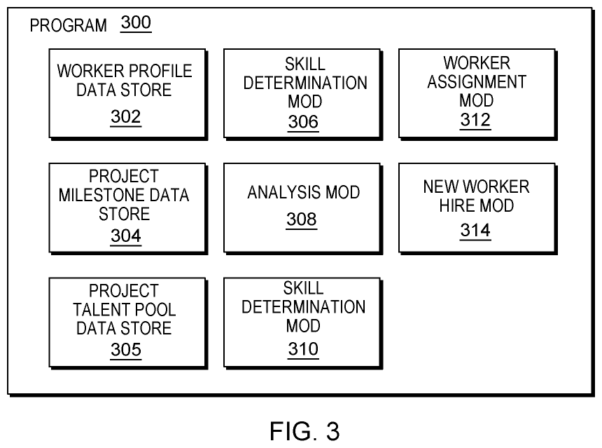

As shown in FIG. 1, networked computers system 100 is an environment in which an example method according to the present invention can be performed. As shown in FIG. 2, flowchart 250 shows an example method according to the present invention. As shown in FIG. 3, program 300 performs or controls performance of at least some of the method operations of flowchart 250. This method and associated software will now be discussed, over the course of the following paragraphs, with extensive reference to the blocks of FIGS. 1, 2 and 3.

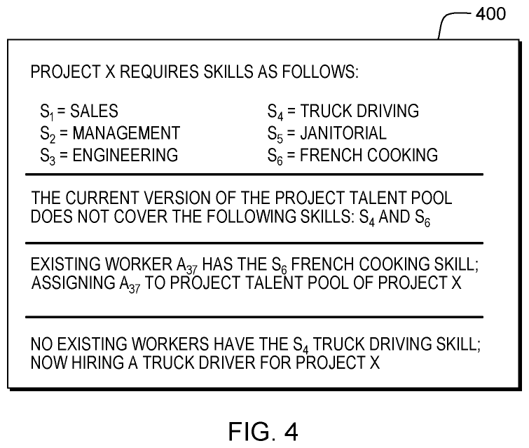

Processing begins at operation S255, where project milestone data store 304 receives milestones (M₁ to Mk) that define a new work project (called Project X, see screen shot 400 of FIG. 4) to be performed by workers of the enterprise (W₁ to Wⱼ) and/or new hires of the enterprise. Information describing skills of the existing workers of the enterprise are stored in worker profile data store 302.

Processing proceeds to operation S260 where skill determination module (“mod”) 306 identifies, by machine logic, the project skills (S₁ to Sₘ) needed to complete work associated with Project X based on the information in the project milestone data store.

Processing proceeds to operation S265, where project talent pool data store 305 receives an initial version of a project talent pool data set including indicative. This initial version of the project data pool identifies the assigned workers (A₁ to Aₙ) that have been initially assigned to Project X.

Processing proceeds to operation S270 where analysis mod 308 analyzes, by machine logic, availability and skills of the initial version of the project talent pool to associate the assigned workers (A₁ to Aₙ) with the project skills (S₁ to Sₘ). This analysis shows which project skills can be sufficiently brought to bear and/or performed by workers that are already in the first version of the project talent pool.

Processing proceeds to operation S275, where skill gap determination mod 310 determines, by machine logic, any skill gap(s) that are not covered by the currently assigned workers in the initial version of the project talent pool. In this example, and as shown in FIG. 4, there are two skills that are not covered, in the initial version of the talent pool as follows: truck driving (S₄); and French cooking (S₆). Turning briefly to the skills that do not represent skill gaps (that is, S₁, S₂, S₃ and S₅), processing proceeds to an end at operation S280.

For skill gap S₆ (French cooking), processing proceeds to operation S285, where skill gap determination mod 310 determines that the French cooking skill can be covered by existing worker A₃₇ who is a French chef of great renown. Accordingly, processing proceeds to operation S295, where worker assignment mod 312 assigns worker A₃₇ to work on Project X to cover the S₆ skill gap, thereby creating a new version of the project talent pool stored in project talent pool data store 305. This new assignment is shown in screen shot 400 of FIG. 4.

For skill gap S₄ (truck driving), processing proceeds to operation S285, where skill gap determination mod 310 determines that the truck driving skill cannot be covered by any existing workers W₁ to Wⱼ currently working for the enterprise. Accordingly, processing proceeds to operation S290, where new worker hire mod 314 hires a truck driver (that is, worker Wⱼ₊₁) to work on Project X to cover the S₄ skill gap, thereby creating a new version of the project talent pool stored in project talent pool data store 305. This new hire is shown in screen shot 400 of FIG. 4.

### III. Further Comments and/or Embodiments

Some embodiments of the present invention recognize the following facts, potential problems and/or potential areas for improvement with respect to the current state of the art: (i) today, current enterprises do not have a means to accurately assess if they have internal skill gaps that need to be closed; (ii) current enterprises do not have a means to accurately assess if the specific market they are in has a potential emerging skill gaps which would require them to take proactive actions to cover such risks and stay ahead of the human commodity skill curve/demand; (iii) large enterprises can struggle with smaller teams having gaps, but still lack macro visibility to know if someone already in the company can fill their gaps; (iv) recruiters at events for the enterprise lack real-time tools or a clear representation of needs for the business and may only optimally find candidates for those they know about or are listed on job boards they own respectively; (v) at times these recruiters have fragmented points of view and a fragmented ability to accurately identify skills across plentiful/dry talent pools; (vi) the ability to know an organization's internal skills gaps can cost money; (vii) determining the potential for internal employees' capability to fill gaps across the enterprise can cost money; (viii) having to look externally or miss an area that could have been covered erodes efficiencies and removes internal promotion opportunities, which potentially impacts retention rates across an enterprise; and/or (ix) enterprises struggle with career paths and helping their employee's ability to grow into future roles that can benefit the company holistically.

Some embodiments of the present invention may include one, or more, of the following operations, features, characteristics and/or advantages: (i) a system and method for capability and skills matrix analysis in gap identification and remediation in enterprise environments; (ii) helps make sure new candidates coming into the enterprise are truly filling needs the company can't; and/or (iii) ensures that candidates are the best options based on their scoring in the system compared to enterprise assets.

Some embodiments of the present invention may include one, or more, of the following operations, features, characteristics and/or advantages: (i) method to effectively analyze talent pools for skill-gaps, reallocation/reuse and/or remediation via unsupervised classification algorithms, and baseline normalization; (ii) method to effectively analyze talent pools for skill-gaps, reallocation/reuse and/or remediation; (iii) uses feature set rationalization, simulation storytelling, training-based outcomes, PCA (principle component analysis) feature pruning; (iv) orthogonal transformations used to convert a set of marked/inputted observations of possibly to correlated variables leading to a sampled skill gap closure; and/or (v) scrapes external sources such as popular social media sites, competitor job listings and other internet sources to identify both skills gaps, as well as brand new exploits and items that could create skills gaps for the enterprise.

A method according to an embodiment of the present invention includes the following operations (not necessarily in the following order): (i) identifying gaps and items are run through analytics to identify if the enterprise can already cover them with their current employees; (ii) responsive to a determination that the enterprise cannot cover gaps with their current employees; (iii) the environment can identify candidates that could be close matches and creates the scenarios needed to test/train these candidates to cover those gaps; (iv) internal employees can use the system and have a baseline created for them, and then be able to pick what they want as an outcome (for example, achieving a specific badge, promotion to a different position, better performance, etc.); (v) based on the selections, and the environment's known baseline for the user, the environment can adjust and help guide them through to where they want to be; (vi) recruiters can submit candidates interested in being hired into the system, scanning them for all known gaps in the company, as well as getting a baseline reading of the candidate; (vii) at the end they are given the ratings to know their baseline against current employees, and also if they can cover a gap the enterprise currently cannot cover (in which case a suitable candidate would be hired as soon as possible); (viii) submitting, by a manager, the resume of a given candidate; (ix) testing the candidate against the skills which that candidate claims to have; and (x) outputting being their actual ranking in those skills, or against the baselines of others on that given team (if known).

Some embodiments of the present invention may include one, or more, of the following operations, features, characteristics and/or advantages: (i) the ability to keep the best workforce to maintain positions in the markets and grow their knowledge; (ii) a method to comprehensively know what full employee skills are past just what someone claims personally or systems that can simply scrape JRSS (Joint Regional Security Stacks) definitions from an HR (human resources) database; (iii) an environment that allows a small team (for example, a small team starting in Canada) to know that the gap they don't have covered could be covered by a current enterprise employee (for example, an employee located in Poland); (iv) better utilizes the employees that an enterprise already has, rather than to have to keep going outside the enterprise to hire; and/or (v) allows current employees to grow to cover those new gaps, or achieve new positions bettering the business units of the enterprise.

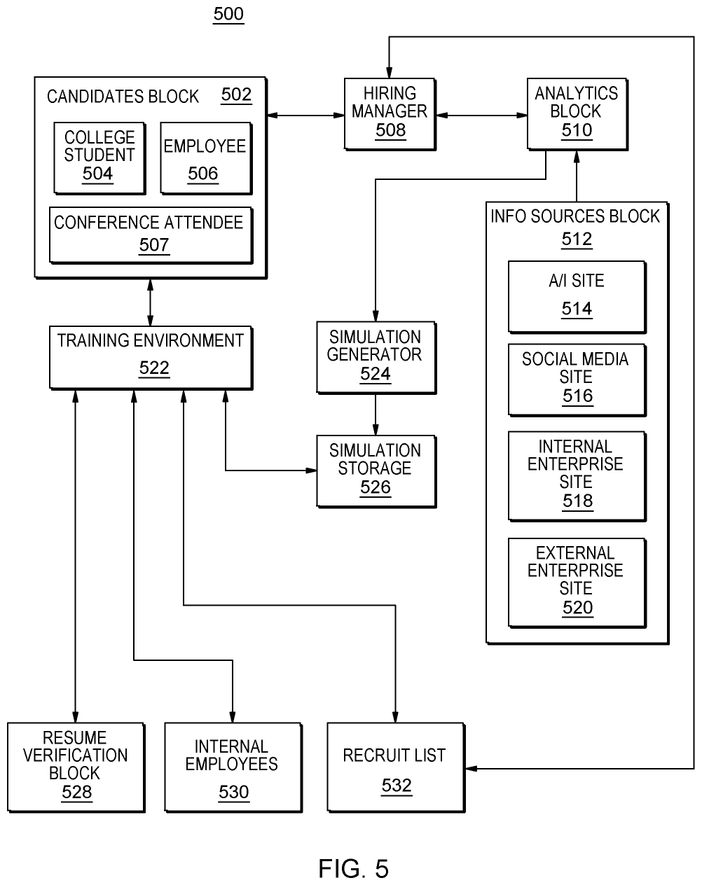

As shown in FIG. 5, computer system 500 includes: candidates block 502; hiring manager 508; analytics block 510; information sources block 512; training environment 522; simulation generator 524; simulation storage 526 (including scenarios, exploits and stories); resume verification block 528 (including train to fill gap instructions/data, identify gap instructions/data, baseline of user instructions/data and train to personal request instructions/data); internal employee 530; and recruit list 532. Candidates block 502 includes: college student 504; employee 506; and conference attendee 507. Information sources block includes AI (artificial intelligence site) 514; social media site 516; internal enterprise site 518; and external enterprise site 520. Training environment 522 includes instructions and data for adapting and morphing based on a user's skill and/or role. For example, in environment 522, a senior architect would have a more difficult learning environment than an early professional. The operations of system 500 will be discussed in the following paragraphs.

Data is ingested into system 500 for analysis using an unsupervised classification algorithm (not separately shown in FIG. 5). In this embodiment, this data includes: (i) social media information; (ii) internal and external job postings (from internal enterprise site 518 and external enterprise site 520); (iii) data from AI site 514; (iv) employment oriented profiles for individuals from social media site 516; and (v) resumes from candidates block 502 and/or hiring manager 508.

The data enumerated in the previous paragraph is captured in a “stated baseline.”

Feature sets are normalized using feature scaling and preprocessing steps as implemented by the following code:

from sklearn.preprocessing import StandardScaler
sc_X=StandardScaler( )
X_train=sc_X.fit_transform(X_train)
X_test=sc_X.transform(X_test)

Simulation storage 526 is created containing: (i) exploits; (ii) stories; (iii) scenarios; and (iv) threats.

The operations of simulation generator 524 will now be discussed. Exploits: The ingestion finds a new zero-day that is dropped, or some exploit with proof of concept code. A simulation engine (not separately shown in FIG. 5) can use that disclosure to create a “scenario” with the given requirements (for example, a specific vendor is vulnerable, specific version leads to a create that is virtualized or deploys physically automatically. Then system 500 uses the proof of concept code to determine how to detect “if it is exploited.” In this detection, a scenario now is used to perform the following types of tests: (i) does current software offering “detect” this if exploited? (testing software); (ii) does a person know how to detect if it is exploited? (Testing user); and (iii) how does a user exploit similarly? (Testing user for knowledge (for example, did the test subject just paste the given proof of concept code online, or did the test subject write their own exploit, etc.). This can then be used to again harden software or detection systems as a loop. User is presented with simulated data stored by the simulation storage container and behavior and response actions are captured. The scenario is what the user then participates in (much like a CTF (capture the flag) environment for each scenario that needs to be tested). Responses are used to provide an evaluated skill baseline using KNN (k nearest neighbors algorithm) infused with NLP (natural language processing) for semantic feature assessment and similarity analysis. The evaluated baseline is compared against the “stated baseline” and provides a gap analysis profile. A training plan is created based on evaluated baseline skill gap analysis.

PCA is used for feature pruning in the form of feedback in order to check if the system needs to remove/extract the unnecessary inputs or not as shown by the following example code:

regressor=LinearRegression( )
regressor.fit(X_train, y_train)
import statsmodels.formula.api as sm
X=np.append(arr=np.ones((50,1)).astype(int), values=X, axis=1)

### X_opt=X[:, [0,1,2,3,4,5]]

regressor_OLS=sm.OLS(endog=y, exog=X_opt).fit( )
regressor_OLS.summary( )

### X_opt=X[:, [0,1,3,4,5]]

regressor_OLS=sm.OLS(endog=y, exog=X_opt).fit( )
regressor_OLS.summary( )

### X_opt=X[:, [0,3,4,5]]

regressor_OLS=sm.OLS(endog=y, exog=X_opt).fit( )
regressor_OLS.summary( )

### X_opt=X[:, [0,3,5]]

regressor_OLS=sm.OLS(endog=y, exog=X_opt).fit( )
regressor_OLS.summary( )

Optimized output is gathered based on extrapolated data and other features are pruned in an iterative fashion as shown above.

Various embodiments of the present invention may be directed to the following use cases: (i) new team is being created and they need candidates, rather than having to hire externally they can query the Enterprise to see if current employees can fill those gaps; (ii) recruiter at events can submit candidates for baseline measuring and also to identify if they fills gaps that are needed by above use case; (iii) analytics scanning the Internet/external sources can identify latest exploits, gaps, skills, etc. and verify if internal coverage for them is already in place—if not, simulation generator begins creating stores/scenarios that users can be sent through to get the coverage or those items; (iv) hiring manger gets CV of candidate and wants to know if they person truly knows the skills claimed (resumes can be imported into environment and candidate is then sent through, with the environment using scenarios to test each of the identified claims of each resume); (v) current employee wants to achieve certain badge, or position in company—given the environment has an established baseline for them, it creates the environment for them to guide them to the knowledge needed for those items; (vi) managers utilize performance improvement plans (PIP) for underperforming employees—this system could be utilized by a manager to submit the expected level of performance by a given employee, and then have the employee submitted and evaluated to see where they fit against the expectations; (vii) the system could be externally available for platforms such as employment-oriented social media sites where a user can submit themselves and find the positions within a company that they are a good candidate for; and/or (viii) the system could also recommend certain certifications or items to work on to make them a better candidate.

Some embodiments of the present invention may include one, or more, of the following operations, features, characteristics and/or advantages: (i) considers gap analysis within a pool of expertise; and/or (ii) provides a mechanism for identifying a baseline of individual skills as they relate to larger gaps within the environment.

A method, according to an embodiment of the present invention, for analyzing skills and identifying actions required to complete a project based on personnel in a project talent pool includes the following operations (not necessarily in the following order): (i) identifying project skills PS (PS1, PS2, . . . , PSk) needed to complete the project based on project milestones PM (PM1, PM2, . . . , PMk) (or goals) in plans for the project; (ii) analyzing availability and skills of the personnel in the project talent pool to associate available project resources P (PR1, PR2, . . . , PRk) (people) with the project milestones PM (PM1, PM2, . . . , PMk); (iii) comparing the available project resources PR (PR1, PR2, . . . , PRk) to the identified project skills PS (PS1, PS2, . . . , PSk) to identify any project gaps PG (PG1, PG2, . . . , PGk) resources wherein the PGi is a subset of project skills PSi available from the talent pool to meet the project milestone PMi; and (iv) identifying actions to prevent the project gaps. Some embodiments may include the following further operation: (v) engaging with a plurality of users in enhancing skill sets and domain knowledge responsive to determining a current skill level and gaps identified during execution of a plurality of tasks.

In some embodiments according to the method of the previous paragraph: (i) the actions are to reallocate resources from the talent pool if available and if not available identify a remediation strategy; (ii) the remediation strategy identifies available resources outside the talent pool and inside a companywide talent pool; and/or (iii) unsupervised learning is used to determine base line skill, training opportunities to fill skill gaps, and reallocation of resources.

Some embodiments of the present invention may include one, or more, of the following operations, features, characteristics and/or advantages: (i) using the specified unsupervised learning for determining training opportunities to fill skill gaps; (ii) includes remediation techniques; and/or (iii) includes a solutions-oriented toolset.

Some embodiments of the present invention may include one, or more, of the following operations, features, characteristics and/or advantages: (i) include contextual language processing, and whereas unique approach; (ii) produces more efficient/effective sub-process outputs; (iii) sub-process outputs contribute to the final production of outcomes using a correlation and adaptation of those sub-processes; (iv) assembles an in depth view of an enterprise's current environment; (v) includes a method for “feature extractions”; (vi) includes a simulation storage method and a simulation generator; (vii) scenario presentation that is simulated by storage container(s); (viii) the ability to capture the behavior and response actions, which is a personalized aspect that is refined as a personalized and/or enterprise compiled analysis of the skill baseline using techniques such as KNN/NLP to contribute to individual/enterprise wide gap analysis; (ix) a training plans are output; (x) features/efficiency is self-pruning and able to be modified based on effectiveness of output; (xi) adapts and morphs based on users skill/role; (xii) adapts and morphs based on enterprise requirements; and/or (xiii) includes external gap analysis/recruiting determinations.

### IV. Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

Including/include/includes: unless otherwise explicitly noted, means “including but not necessarily limited to.”

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

1. A computer-implemented method (CIM) for use by an enterprise that has a plurality of workers (W₁ to Wⱼ, where j is an integer value), the CIM comprising:
receiving a project milestone data set including information identifying and relating to a plurality of milestones (M₁ to Mₖ, where k is an integer) that define a work project to be performed by the enterprise;
identifying, by machine logic, a plurality of project skills (S₁ to Sₘ, where m is an integer) needed to complete work associated with the work project based on the project milestone data set;
receiving a first version of a project talent pool data set including indicative of a first version of a project talent pool, with the first version of the project talent pool being a plurality of assigned workers (A₁ to Aₙ, where n is an integer) which is a subset of the plurality of workers of the enterprise, with the plurality of assigned workers being workers currently assigned to work on the work project;
analyzing, by machine logic, availability and skills of the first version of the project talent pool to associate the assigned workers with the project skills;
determining, by machine logic, that first project skill S₁ is a skill that is not met by any of the assigned workers of the first version of the project talent pool to identify first project skill S₁ as a first skill gap with respect to the work project and the first version of the project talent pool with the determination including the following sub-operations:
performing an unsupervised classification algorithm on the project talent pool, and
performing baseline normalization on the project talent pool; and
performing the work project, which is a commercial project consisting of profitable work for the enterprise, using a human resource selected to cover the determined skill gap S₁.

2. The CIM of claim 1 further comprising:
performing feature set rationalization on the project talent pool;
(iv) orthogonal transformations used to convert a set of marked/inputted observations of possibly to correlated variables leading to a sampled skill gap closure.

3. The CIM of claim 1 further comprising:
performing PCA (principle component analysis) feature pruning with respect to the project talent pool.

4-18. (canceled)

19. A computer program product (CPP) for use by an enterprise that has a plurality of workers (W₁ to Wⱼ, where j is an integer value), the CPP comprising:
a set of storage device(s); and
computer code stored collectively in the set of storage device(s), with the computer code including data and instructions to cause a processor(s) set to perform at least the following operations:
receiving a project milestone data set including information identifying and relating to a plurality of milestones (M₁ to Mₖ, where k is an integer) that define a work project to be performed by the enterprise,
identifying, by machine logic, a plurality of project skills (S₁ to Sₘ, where m is an integer) needed to complete work associated with the work project based on the project milestone data set,
receiving a first version of a project talent pool data set including indicative of a first version of a project talent pool, with the first version of the project talent pool being a plurality of assigned workers (A₁ to Aₙ, where n is an integer) which is a subset of the plurality of workers of the enterprise, with the plurality of assigned workers being workers currently assigned to work on the work project,
analyzing, by machine logic, availability and skills of the first version of the project talent pool to associate the assigned workers with the project skills,
determining, by machine logic, that first project skill S₁ is a skill that is not met by any of the assigned workers of the first version of the project talent pool to identify first project skill S₁ as a first skill gap with respect to the work project and the first version of the project talent pool with the determination including the following sub-operations:
performing an unsupervised classification algorithm on the project talent pool, and
performing baseline normalization on the project talent pool, and
performing the work project, which is a commercial project consisting of profitable work for the enterprise, using a human resource selected to cover the determined skill gap S₁.

20. The CPP of claim 19 wherein the computer code further includes instructions for causing the processor(s) set to perform the following operation(s):
performing feature set rationalization on the project talent pool;
(iv) orthogonal transformations used to convert a set of marked/inputted observations of possibly to correlated variables leading to a sampled skill gap closure.

21. The CPP of claim 19 wherein the computer code further includes instructions for causing the processor(s) set to perform the following operation(s):
performing PCA (principle component analysis) feature pruning with respect to the project talent pool.

22. A computer system (CS) for use by an enterprise that has a plurality of workers (W₁ to Wⱼ, where j is an integer value), the CS comprising:
a processor(s) set;
a set of storage device(s); and
computer code stored collectively in the set of storage device(s), with the computer code including data and instructions to cause the processor(s) set to perform at least the following operations:
receiving a project milestone data set including information identifying and relating to a plurality of milestones (M₁ to Mₖ, where k is an integer) that define a work project to be performed by the enterprise,
identifying, by machine logic, a plurality of project skills (S₁ to Sₘ, where m is an integer) needed to complete work associated with the work project based on the project milestone data set,
receiving a first version of a project talent pool data set including indicative of a first version of a project talent pool, with the first version of the project talent pool being a plurality of assigned workers (A₁ to Aₙ, where n is an integer) which is a subset of the plurality of workers of the enterprise, with the plurality of assigned workers being workers currently assigned to work on the work project,
analyzing, by machine logic, availability and skills of the first version of the project talent pool to associate the assigned workers with the project skills,
determining, by machine logic, that first project skill S₁ is a skill that is not met by any of the assigned workers of the first version of the project talent pool to identify first project skill S₁ as a first skill gap with respect to the work project and the first version of the project talent pool with the determination including the following sub-operations:
performing an unsupervised classification algorithm on the project talent pool, and
performing baseline normalization on the project talent pool, and
performing the work project, which is a commercial project consisting of profitable work for the enterprise, using a human resource selected to cover the determined skill gap S₁.

23. The CS of claim 22 wherein the computer code further includes instructions for causing the processor(s) set to perform the following operation(s):
performing feature set rationalization on the project talent pool;
(iv) orthogonal transformations used to convert a set of marked/inputted observations of possibly to correlated variables leading to a sampled skill gap closure.

24. The CS of claim 22 wherein the computer code further includes instructions for causing the processor(s) set to perform the following operation(s):
performing PCA (principle component analysis) feature pruning with respect to the project talent pool.
